(19) United States
(12) Patent Application Publication
(10) Pub. No.: US 2024/0280700 A1
(43) Pub. Date: Aug. 22, 2024

(54) OPTICAL TRACKING SYSTEM WITH DATA TRANSMISSION VIA INFRARED

(71) Applicant: Universal City Studios LLC, Universal City, CA (US)

(72) Inventors: Akiva Meir Krauthamer, Orlando, FL (US); Aaron Chandler Jeromin, Winter Garden, FL (US)

(21) Appl. No.: 18/582,506

(22) Filed: Feb. 20, 2024

Related U.S. Application Data
(60) Provisional application No. 63/447,206, filed on Feb. 21, 2023.

(51) Int. Cl. G01S 17/66; G01S 7/48; G01S 17/42; H04B 10/112; H04B 10/50

(52) U.S. Cl. CPC G01S 17/66; G01S 7/4808; G01S 17/42; H04B 10/1121; H04B 10/502

(57) ABSTRACT

An optical tracking system may include optical sensors (e.g., infrared (IR) cameras) coupled with illuminators (e.g., IR light-emitting diodes (LEDs)). The optical tracking system may track an object having retro-reflective markers. The light from the illuminators may be reflected by the retro-reflective markers and detected by the optical sensors. In certain cases, the object may include emitters (e.g., IR LEDs) such that active light emitted from the object is directly detected by the optical sensors. The optical sensors generate data based on detected light and send the data to a controller. The controller may compute position data (e.g., indicative of a relative 2D position between the object and the optical sensors). The controller may send the position data to the object optically (e.g., using IR light).

### CROSS-REFERENCE TO RELATED APPLICATION

This application claims priority to and the benefit of U.S. Provisional Application No. 63/447,206, entitled “OPTICAL TRACKING SYSTEM WITH DATA TRANSMISSION VIA INFRARED,” filed Feb. 21, 2023, which is hereby incorporated by reference in its entirety for all purposes.

### BACKGROUND

An automatic tracking system may have various applications (e.g., tracking objects and making alarms based on the tracked objects) in certain places (e.g., amusement parks, buildings, parking lots). One type of automatic tracking system may be an optical tracking system that may utilize a variety of optical sensors for detecting light reflected from one or more tracked objects. Based on the detected light, the optical tracking system may generate position data indicative of respective positions of the one or more tracked objects.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a system includes an optical sensor configured to detect an object in an area. The system also includes a controller configured to receive first data indicative of a first location of the object from the optical sensor, receive second data indicative of a second location of the optical sensor, compute position data based on the first location and the second location, and transmit the position data to the object via an optical signal.

In an embodiment, an optical tracking system includes an optical sensor configured to detect a first object and a second object in an area. The system also includes a controller configured to receive first data indicative of a first location of the first object from the optical sensor. The controller also receives second data indicative of a second location of the second object from the optical sensor, and receives third data indicative of an additional location of the optical sensor. The controller computes first position data for the first object based on the first location and the additional location, and computes second position data for the second object based on the second location and the additional location. The controller also instructs a light emitter to transmit the first position data to the first object via a first optical signal, and instructs the light emitter to transmit the second position data to the second object via a second optical signal.

In an embodiment, a method includes receiving, at one or more processors, location data from an optical sensor configured to detect light from an object in an area. The method also includes computing, via the one or more processors, position data indicative of a relative position between the object and the area based on the location data. The method further includes sending, via an optical transmitter, the position data to the object.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an optical tracking system that includes a controller coupled to multiple optical sensors equipped with light emitters that facilitate tracking an object with a retroflector, in accordance with an embodiment of the present disclosure;

FIG. 2 is a schematic diagram of the optical tracking system that includes the controller coupled to the multiple optical sensors that detect light emitted from light emitters coupled to the object, in accordance with an embodiment of the present disclosure;

FIG. 3 is a schematic diagram of the optical tracking system that includes the controller coupled to an object (e.g., a head-mounted display [HMD]) worn by a guest, in accordance with an embodiment of the present disclosure;

FIG. 4 is a schematic diagram of the optical tracking system that includes one optical sensor with a light emitter that facilitates tracking multiple objects, in accordance with an embodiment of the present disclosure;

FIG. 5 is an example application in an amusement park using the optical tracking system of FIG. 4, in accordance with an embodiment of the present disclosure; and

FIG. 6 is a flow diagram of a method for using the optical tracking system to track the object, in accordance with an embodiment of the present disclosure.

### DETAILED DESCRIPTION

One or more specific embodiments will be described below. In an effort to provide a concise description of these embodiments, not all features of an actual implementation are described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

In many situations, optical tracking systems such as a motion capture system may be useful. One common type of motion capture system uses a set of infrared (IR) cameras, and each IR camera includes a lens and IR light sources pointing the same direction as the lens. Object(s) to be tracked have retro-reflective markers. The IR light sources emit IR light, and the light bounces off the retro-reflective markers and back to the lenses of the IR cameras. All the IR cameras send their images to a controller that calculates relative position of all the IR cameras and the object(s) in three-dimensional (3D) space. The controller transmits data using wires, wireless and/or radiofrequencies to other devices for use in a larger system.

One of the downsides of this type of motion capture system is that if the object(s) being tracked is to receive its own position data, the object(s) needs to have a wired, wireless connection or a radio frequency connection. The wired connection may limit movement of the object(s). Further, the amount of latency between the images being captured and the object(s) receiving its position data may sometimes be high due to the limits of transmitting data wirelessly via radiofrequencies. Keeping latency low is especially important for certain uses, such as augmented reality (AR) and virtual reality (VR). For example, it is presently recognized that it is especially important for a head-mounted display (HMD) that is configured to be worn by a guest and to project AR images to be overlaid onto a real-world environment for visualization by the guest (e.g., to project the AR images in a coordinated manner with the real-world environment based on the position data of the HMD relative to the real-world environment in space).

Additionally, in this type of motion capture system, the time it takes to transfer the images to the controller and process the retro-reflective marker positions in software adds additional latency. Furthermore, in order to transmit the data to another system, or back to the object(s) itself via radiofrequencies, a meshed network should be setup and carefully calibrated to avoid interference and occlusion from physical structures.

The present disclosure is related to an optical tracking system that may track one or more objects (e.g., portable devices, including wearable devices; vehicles) and provide position data to the one or more objects. The optical tracking system may be utilized in any of a variety of environments, such as amusement parks, theatres, restaurants, working places, residential places, parking places, and/or storage places, for example. In an embodiment, the optical tracking system may utilize a variety of optical sensors (e.g., cameras, light detectors, LiDAR) for detecting light (e.g., IR light; visible light) reflected or emitted from the one or more objects. The optical tracking system may analyze received signals from the optical sensors, generate position data (e.g., relative positions between the optical sensors and the one or more objects; relative positions between the one or more objects and an environment), and transmit the position data to the one or more objects. In this way, each object of the one or more objects may be aware of their respective location relative to the environment. Advantageously, the optical tracking system may send the position data to the one or more objects via a light signal, such as IR light.

In an embodiment, the optical tracking system may include optical sensors each coupled to one or more illuminators (e.g., light emitters; light-emitting diodes [LEDs], an array of LEDs or other type of actively powered illuminators) that may emit light (e.g., IR light, visible light) that illuminate the one or more objects. Each object of the one or more objects may have retro-reflective markers that may reflect a portion of the light emitted from the one or more illuminators. The optical sensors may detect the reflected light and generate signals indicative of a location of the object of the one or more objects in the environment. Each optical sensor of the optical sensors may send the signal to a controller (e.g., communicatively coupled to the camera or built into the camera), which may process the signal and generate position data (e.g., including a relative position between the object and the optical sensor; a relative position between the object and the environment, which may be derived from or determined based on the relative position between the object and the optical sensor as well as a known relationship between the optical sensor and the environment). Additionally, the controller may send the position data to the object via a light signal (e.g., using the one or more illuminators; modulated light signal to encode the position data). The object may use an optical receiver to receive the light signal, such that the object may be aware of the location of the object (e.g., the location with respect to the optical sensor and/or the environment).

In an embodiment, the one or more objects may have coupled emitters (e.g., LEDs, an array of LEDs or other type of actively powered illuminators, light sources shining in a bright but brief, sudden, or intermittent way, such as flashing LEDs) that may emit light (e.g., IR light, visible light). The emitted light may be detected by the optical sensors within proximity of the one or more objects. Upon receipt of the emitted light from a particular object of the one or more objects, each optical sensor of the one or more optical sensors may send a signal indicative of a location of the particular object to the controller, which may process the signal and generate position data for the particular object. The controller may instruct one or more illuminators in the environment to emit a light signal including the position data. The object may receive the position data via an optical receiver.

The optical tracking system may have certain advantages, such as improved data transmission and reduced signal interference. For example, since the optical sensors utilize line of sight to the one or more objects to detect the one or more objects, that same line of sight may be used to send data using one or more illuminators at the optical sensors to the one or more objects. Using light for data transmission also decreases the chances of interference from other devices, such as cell phones (e.g., as compared to using radiofrequency for data transmission).

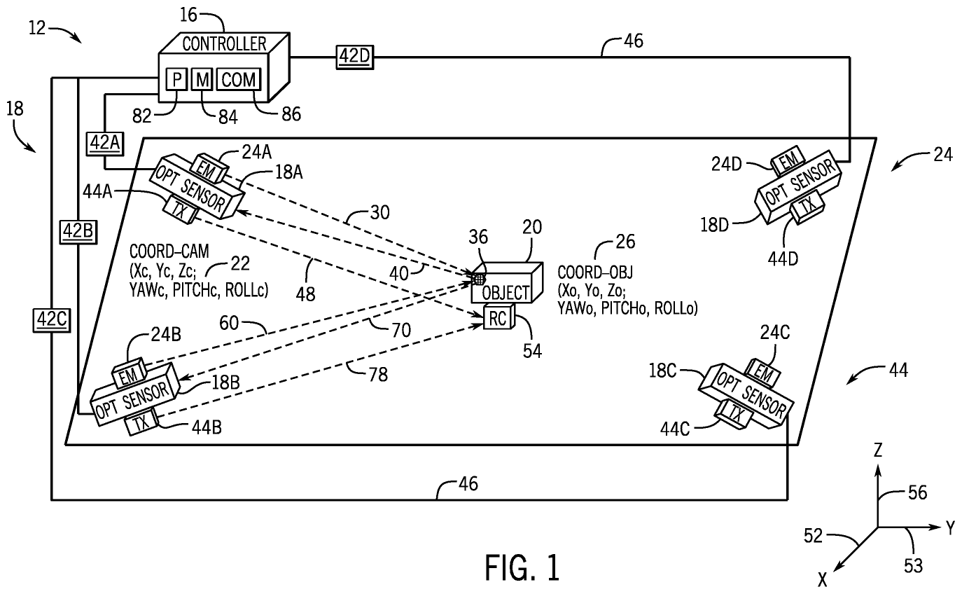

With the foregoing in mind, FIG. 1 is a schematic diagram of an embodiment of an optical tracking system 12 that includes a controller (e.g., control system, electric controller) 16 coupled to optical sensors 18 equipped with light emitters 24 for tracking an object 20 located in an area 14 (e.g., an amusement park, theatre, restaurant, working place, residential place, parking place, storage place). As shown, the controller 16 may be located in a control room and communicatively coupled (e.g., wired or wireless) to the optical sensors 18.

In an embodiment, the optical sensors 18 may include cameras operating in visible light (e.g., a wavelength range from 380 to 700 nanometers), in infrared (IR) light (e.g., a wavelength range from 780 nanometers to 1 millimeter), or in other suitable light. In an embodiment, the optical sensors 18 may include other optical sensors and optical tracking devices, such as Light Detection and Ranging (LiDAR) sensors or IR sensors used to detect distances based on a detection of light (e.g., modulated light), optical sensors providing artificial vision (e.g., to the controller 16) for object recognition and tracking, or any combination thereof.

The optical sensors 18 may include the light emitters 24 that may emit light (e.g., visible or IR light) illuminating the object 20. For example, an optical sensor 18A, 18B, 18C, and 18D may include an emitter 24A, 24B, 24C, and 24D, respectively. Each emitter 24A, 24B, 24C, and 24D may include one or more light emission units (e.g., IR or visible light-emitting diodes [LEDs]) that may produce light (e.g., IR or visible light) to illuminate objects 20 within the area 14. For example, the light emitter 24A coupled to the optical sensor 18A may emit light 30 to illuminate the object 20, and the light emitter 24B coupled to the optical sensor 18B may emit light 60 to illuminate the object 20 as well.

The object 20 may be any optically trackable object, such as a portable object configured to be worn or carried by a guest. For example, the portable object may include any handheld and/or wearable device (e.g., head-mounted display [HMD], cellphones, tablets, souvenirs, toys, bands, wands). However, it should be appreciated that the object 20 may include other types of objects, such as furniture, vehicles (e.g., amusement park ride vehicles), and the like. The object 20 may include a retroreflector 36 (e.g., at least one; a retro-reflective marker, a reflection device, or a reflection surface) that reflects radiation (e.g., light) back to the light emitters 24 (e.g., with limited scattering). In certain cases, the retroreflector 36 may be coupled to or integrated into the object 20 (e.g., via fasteners, such as adhesive, threads, bolts; woven, painted, machined, molded).

The optical sensors 18 (e.g., optical sensors 18A-18D) may detect the light (e.g., light emitted from the light emitters 24 and reaching the object 20) reflected back from the object 20. For example, the optical sensor 18A may detect reflected light 40 (e.g., a portion of the light 30 emitted from the light emitter 24A and reflected back from the retroreflector 36 of the object 20). Similarly, the optical sensor 18B may detect reflected light 70 (e.g., a portion of the light 60 emitted from the light emitter 24B and reflected back from the retroreflector 36 of the object 20).

After detecting the reflected light (e.g., the light 40 and 70), the optical sensors 18 may generate signals indicative of a location of the object 20. For example, the optical sensor 18A may generate a signal 42A based on the detected light 40 (e.g., based on arriving time, direction, light intensity, and/or other attributes, such as frequency and/or polarization, of the light 40). The signal 42A may be indicative of a relative position between the object 20 and the optical sensor 18A. The optical sensor 18B may generate a signal 42B based on the detected light 70 (e.g., based on arriving time, direction, light intensity, and/or other attributes of the light 70). The signal 42B may be indicative of a relative position between the object 20 and the optical sensor 18B. Similarly, other optical sensors (e.g., 18C, 18D) may generate corresponding signals (e.g., 42C, 42D) based on the detected light reflected from the retroreflector 36 of the object 20.

In an embodiment, each of the signals (e.g., 42A-42D) may include additional information. For example, the signal 42A may include information indicative of a location of the optical sensor 18A (e.g., a relative location between the optical sensor 18A and the area 14, such as according to a local coordinate system established for the area 14; an identifier of the optical sensor 18A that links to the location of the optical sensor 18A). Such information may be used for computing locations of the object 20 with respect to the area 14 based on the signals (e.g., 42A-42D).

The optical sensors 18 (e.g., 18A-18D) may transmit (e.g., via communication lines, such as electric cables 46 or fiber optic cables) the signals (e.g., 42A-42D) to the controller 16. The controller 16 may include one or more processors 82, a memory device 84, and a communication component 86. In an embodiment, the controller 16 may include additional components, such as receivers and transmitters for receiving or transmitting data (e.g., via radiofrequency, optical frequency, other communication frequencies, or any combination thereof). In an embodiment, the controller 16 may include input/output devices and/or displays that may enable a user (e.g., a guest) associated with the object 20 to interact with certain data (e.g., position maps, images).

In an embodiment, each of the optical sensors 18 may send a simplified version of data indicative of the location of the object 20 to the controller 16. For example, the optical sensor 18A (including a camera) may do a basic blob detection to identify where the retroreflector 36 is in captured image frames and then transmit only the image frames with identified retroreflector 36 to the controller 16, thereby reducing an amount of transmitted data and increasing an overall bandwidth of the optical tracking system 12.

The processors 82 may process instructions for execution within the controller 16. The processors 82 may include single-threaded processor(s), multi-threaded processor(s), or both. The processors 82 may process instructions stored in the memory 84. The processors 82 may also include hardware-based processor(s) each including one or more cores. The processors 82 may include general purpose processor(s), special purpose processor(s), or both. The processors 82 may include one or more general purpose microprocessors, one or more application specific processors (ASICs), one or more field programmable gate arrays (FPGAs), or any combination thereof. For example, the special purpose processor(s) may include artificial intelligence processor(s) designed on the basis of machine learning and artificial neural network. The artificial intelligence processor(s) may read various position data associated with the object 20, other objects close to the object 20, and the optical sensors 18, and perform computations based on the position data. The processors 82 may be communicatively coupled to other internal components (such as the memory 84, the communication component 86, input/output devices, and displays).

The memory 84 may be any suitable articles of manufacture that may serve as media to store processor-executable code, data, or the like. These articles of manufacture may represent computer-readable media (e.g., any suitable form of memory or storage) that may store the processor-executable code used by the processors 82 to perform the presently disclosed techniques. As used herein, applications may include any suitable computer software or program that may be installed onto the controller 16 and executed by the processors 82. The memory device 84 may represent non-transitory computer-readable media (e.g., any suitable form of memory or storage) that may store the processor-executable code used by the processors 82 to perform various techniques described herein. For example, the memory device 84 may include random access memory (RAM), read only memory (ROM), rewritable non-volatile memory such as flash memory, hard drives, optical discs, and/or the like. It should be noted that non-transitory merely indicates that the media is tangible and not a signal.

The communication component 86 may be a wireless or wired communication component that may facilitate communication between the controller 16 and other devices (e.g., the optical sensors 18) via a network. For example, the communication component 86 may allow the controller 16 to obtain data from the variety of data sources, such as the optical sensors 18, one or more databases (e.g., optical sensor location database, controller location database, a map database), user devices (e.g., the object 20, HMDs, smart phones, tablets), vehicle systems (e.g., driving systems on or in ride vehicles), and the like. The communication component 86 may receive and send notifications to the user devices and/or the vehicle systems. The communication component 86 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processors 82 may be configured to receive (e.g., via the communication component 86) the signals 42A-42D transmitted from the optical sensors 18A-18D. In response, the processors 82 may compute position data associated with the object 20. For example, based on the signal 42A, the processors 82 may compute the position data of the object 20 with respect to the optical sensor 18A. Computing the position data may include analyzing the attributes of the light 40, computing a relative distance and orientation between the object 20 and the optical sensor 18A, retrieving coordinates 22 of the optical sensor 18A, and computing coordinates 26 of the object 20 (e.g., relative coordinates between the object 20 and the area 14).

The coordinates 22 may include coordinate data of the optical sensor 18A, such as Cartesian coordinates (X_{C}, Y_{C}, and Z_{C}) measured with respect to a Cartesian coordinate system including axis 52, axis 53, and axis 56. Additionally, the coordinate data may include orientation data, such as YAW_{C}, PITCH_{C}, and ROLL_{C} indicative of the orientation of the optical sensor 18A. The coordinates 22 may be relative coordinates (e.g., in a local coordinate system established for the area 14) or non-relative coordinates (e.g., in a global coordinate system, such as a global positioning system [GPS] coordinate).

The coordinates 26 may include coordinate data of the object 20 with respect to the optical sensors 18. For example, the coordinates 26 may include Cartesian coordinates (X_{O}, Y_{O}, and Z_{O}) of the object 20 with respect to the optical sensor 18A. Additionally, the coordinate data of the object 20 may include orientation data, such as YAW_{O}, PITCH_{O}, and ROLL_{O} indicative of the orientation of the object 20 with respect to the optical sensor 18A.

In an embodiment, the signals (e.g., 42A-42D) may not include the location of the optical sensors (e.g., 18A-18D)). For example, the controller 16 may store (e.g., via the memory device 84) the respective coordinates for each of the optical sensors 18. In such case, the controller 16 may use the stored location of the optical sensors (e.g., 18A-18D) to compute the coordinates 26 of the object 20.

After computing the coordinates 26 of the object 20, the controller 16 may send (e.g., via the communication component 88) the coordinates 26 to the optical sensors 18. For example, the controller 16 may send a portion of the coordinates 26 (e.g., a portion corresponding to the relative coordinate of the object 20 with respect to the optical sensor 18A) to the optical sensor 18A. In response, the optical sensor 18A may send an optical signal to the object 20. The optical signal may include the relative coordinate of the object 20 with respect to the optical sensor 18A. The optical sensor 18A may use an optical transmitter 44A to generate the optical signal and transmit the optical signal via a light 48 (e.g., IR or visible light; modulated light signal to encode the position data). The object 20 may include an optical receiver 54 configured to receive the light 48 carrying the position data (e.g., relative coordinate of the object 20 with respect to the optical sensor 18A). The object 20 may utilize the position data and enable the object 20 to be aware of a location of the object 20 with respect to the optical sensor 18A and/or the area 14. It should be appreciated that the optical sensor 18A may use the emitter 24A to generate the optical signal and transmit the optical signal via the light 48 (e.g., IR or visible light; modulated light signal to encode the position data). In such cases, the optical sensor 18A may include the emitter 24A to emit the light 30 to be reflected back from the retroreflector 36 of the object 20, and also to emit the light 48 that provides the position data to the object 20 (e.g., the optical sensor 18A includes the emitter 24A and is devoid of a separate optical transmitter, such as devoid of the optical transmitter 44A shown in FIG. 1; the emitter 24A is or operates as the optical transmitter 44A). Indeed, any of the optical sensors 18A, 18B, 18C, 18D may utilize respective emitters 24A, 24B, 24C, 24D to track the object 20 and also to provide the position data to the object 20.

Similarly, the controller 16 may send a different portion of the coordinates 26 (e.g., a portion corresponding to the relative coordinate of the object 20 with respect to the optical sensor 18B) to the optical sensor 18B. In response, the optical sensor 18B may send a different optical signal to the object 20. The different optical signal may include the relative coordinate of the object 20 with respect to the optical sensor 18B. The optical sensor 18B may use an optical transmitter 44B (or the emitter 24B) to generate the optical signal and transmit the optical signal via a light 78 (e.g., IR or visible light). The object 20 may use the optical receiver 54 to receive the light 78 carrying the position data (e.g., relative coordinate of the object 20 with respect to the optical sensor 18B). The object 20 may utilize the position data and enable the object 20 to be aware of a location of the object 20 with respect to the optical sensor 18A and/or the area 14. Further, it should be appreciated that the controller 16 may determine the coordinates 26 of the object 20 (e.g., relative to the area 14) and instruct one or more of the optical sensors (e.g., 18A and/or 18B) to provide the coordinates 26 of the object 20 to the object 20 via respective optical signals (e.g., light 48 and/or 78).

In an embodiment, the light emitters 24 on or in the optical sensors 18 may include digital projectors or similar directional light sources. Such directional light sources may allow each of the optical sensors 18 to transmit the position data to specific tracked objects (e.g., to the object 20) without sending the same data to other tracked objects (e.g., other than the object 20), thereby increasing the overall bandwidth of the optical tracking system 12.

In an embodiment, based on the position data received via the optical receiver 54, the object 20 may utilize certain devices (e.g., on the object 20 and/or connected devices, such as a ride vehicle controller that is on-board a ride vehicle and wired to the object 20) to further process and/or utilize the position data. For example, the object 20 may be an HMD that utilizes the coordinates 26 to retrieve and to display imagery via the HMD to enable a guest wearing the HMD to view the imagery overlaid onto a real-world environment in the area 14 in a coordinated manner (e.g., the imagery is overlaid to appear integrated into the real-world environment). As another example, the position data may trigger effects (e.g., lights, sounds, haptics) on the object 20 (e.g., the object 20 is programmed to output certain effects based on the position and/or the orientation of the object 20). As another example, the object 20 may be a mobile phone case that supports a mobile phone and communicatively couples (e.g., wired or wireless) to the mobile phone. Then, the mobile phone case may communicate the position data to the mobile phone, and an application on the mobile phone may utilize the position data to display relevant information, enable interaction with the area 14 via inputs on the mobile phone, and so forth. As another example, the position data may enable the object 20 and/or the connected devices to obtain and/or to determine enhanced position data, such as a position map indicative of a relative position of the object 20 with respect to other objects (e.g., other HMDs in the ride vehicle) in the area 14. In this way, the optical tracking system 12 may enable certain coordinated events (e.g., theme park events including multiple guests and/or multiple rider cars) based on the relative positions of multiple objects, including the object 20.

Although the controller 16 and the optical sensors 18 are described as being communicatively coupled to each other via the electrical cables 46, it should be noted that, in an embodiment, the controller 16 and the optical sensors 18 may be communicatively coupled to each other via radiofrequency signals, optical signals (e.g., using visible light or IR light). In an embodiment, the controller 16 or the optical sensors 18 may transmit the position data using wired or radiofrequency signals, in addition to the light signals (e.g., via the light 48 and 78) to the object 20. Such additional data transmissions may act as backup communications (e.g., when default communications are malfunctioned, interfered, or obstructed).

In certain cases, the optical tracking system 12 may be implemented using different methods with more or less devices (e.g., tracking devices, such as the optical sensors 18) or components (e.g., the light emitters 24). For example, in an embodiment, the light emitters 24 may be coupled to one or more structures in the area 14, such that the optical sensors 18 may not include the light emitters 24. This may enable the light emitters 24 to be hidden from view of the guests in the area 14. For example, the object 20 may be on, in, or covering a tabletop for visualization by the guests in the area 14, and at least a portion of the object 20 (e.g., a base of the object 20) with the optical receiver 54 may be exposed to a space below the tabletop. Then, the light emitters 24 may be hidden under the tabletop communicate the position data for detection by the optical receiver 54. In an embodiment, a single optical sensor 18 may be used to track the object 20 in the area 14. In an embodiment, certain devices or components may be combinations of tracked objects and tracking devices.

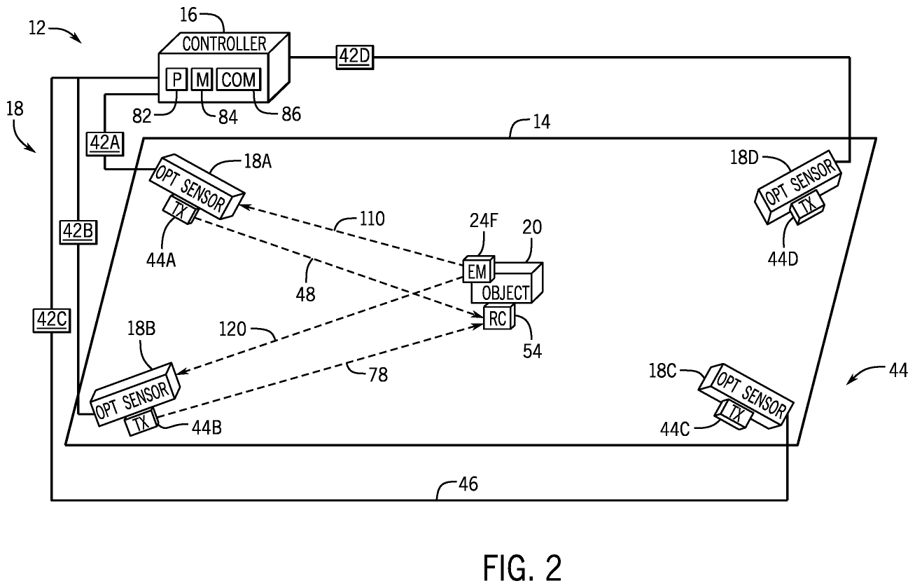

With the preceding in mind, FIG. 2 is a schematic diagram of an embodiment of the optical tracking system 12 that includes the controller 16 coupled to the optical sensors 18 (e.g., optical sensors 18A-18D). The optical sensors 18 are configured to receive light 48 and/or 78 emitted from a light emitter 24F coupled to the object 20. The optical sensors 18 may not include the light emitters (e.g., the light emitters 24 shown in FIG. 1) that emit light 48 and/or 78 (e.g., visible or IR light) illuminating the object 20. Instead, the object 20 may have the light emitter 24F that may emit light 48 and/or 78 (e.g., visible or IR light) that is detectable by the optical sensors 18. For example, the light emitter 24F may be coupled to and/or integrated into the object 20.

The light emitter 24F may emit light 48 and/or 78 (e.g., visible or IR light). A portion of the light (e.g., light 110) may reach the optical sensor 18A. The optical sensor 18A may detect the light 110 and generate a signal indicative of a location of the object 20 with respect to the optical sensor 18A. For example, the optical sensor 18A may generate the signal 42A based on the detected light 110 (e.g., based on arriving time, direction, light intensity, and/or other attributes of the light 110). The signal 42A may be indicative of a relative position between the object 20 and the optical sensor 18A.

A different portion of the light (e.g., light 120) may reach the optical sensor 18B. The optical sensor 18B may detect the light 120 and generate a signal indicative of a location of the object 20 with respect to the optical sensor 18B. For example, the optical sensor 18B may generate the signal 42B based on the detected light 120 (e.g., based on arriving time, direction, light intensity, and/or other attributes of the light 120). The signal 42B may be indicative of a relative position between the object 20 and the optical sensor 18B. Similarly, other optical sensors (e.g., 18C, 18D) may generate corresponding signals (e.g., 42C, 42D) based on the detected light emitted from the light emitter 24F of the object 20.

As described with reference to FIG. 1, the processors 82 receive (e.g., via the communication component 86) the signals 42A-42D transmitted from the optical sensors 18A-18D and compute position data (e.g., the coordinates 26) associated with the object 20. After computing the coordinates 26 of the object 20, the controller 16 may send (e.g., via the communication component 88) the coordinates 26 to one or more of the optical sensors 18. In response, the one or more of the optical sensors 18 may send (e.g., via a corresponding optical transmitter 44) an optical signal to the object 20 via corresponding light (e.g., the light 48 or 78). The object 20 may use the optical receiver 54 to receive the light 48 and/or 78 carrying the position data (e.g., the coordinates 26 of the object 20). As described herein, based on the position data received via the optical receiver 54, the object 20 may utilize certain devices to further process and/or utilize the position data. For example, the position data may trigger effects (e.g., lights, sounds, haptics) on the object 20 (e.g., the object 20 is programmed to output certain effects based on the position and/or the orientation of the object 20).

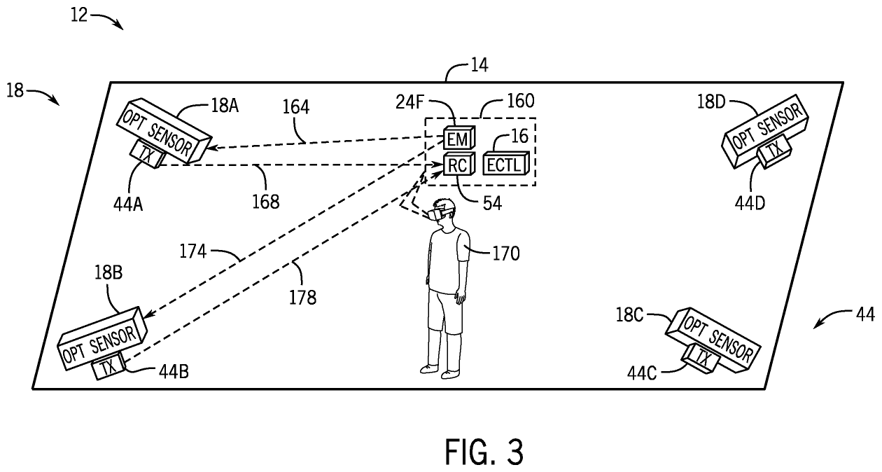

FIG. 3 is a schematic diagram of an embodiment of the optical tracking system 12 that includes the controller 16 coupled to an object (e.g., a head-mounted (HMD) 160) worn by a guest 170 in the area 14. Similar to FIG. 2, the optical sensors 18 may not include the light emitters 24 that emit light (e.g., visible or IR light) illuminating the HMD 160 and the guest 170. As illustrated, the HMD 160 may include the light emitter 24F (e.g., as a built-in device) that may emit light (e.g., visible or IR light) that is detectable by the optical sensors 18. As shown, the controller 16 may be a part of the HMD 160.

For example, a portion of the light (e.g., light 164) emitted from the light emitter 24F in the HMD 160 may reach the optical sensor 18A. The optical sensor 18A may detect the light 164 and generate a signal indicative of a location of the HMD 160 (and the guest 170) with respect to the optical sensor 18A. The optical sensor 18A may generate the signal based on the detected light 164 (e.g., based on arriving time, direction, light intensity, and/or other attributes of the light 164). The signal may be indicative of a relative position between the HMD 160 and the optical sensor 18A.

The optical sensor 18A may send to the HMD 160 the signal as an optical signal (e.g., via the optical transmitter 44A and encoded in light 168). The HMD 160 may use the optical receiver 54 to receive the light 168. Further, the HMD 160 may use the controller 16 to compute position data associated with the HMD 160 (e.g., the coordinates 26 with respect to the optical sensor 18A and/or the area 14). The coordinates 26 may include coordinate data of the HMD 160 with respect to the optical sensors 18A and/or the area 14.

Similarly, the optical sensor 18B may send to the HMD 160 a different signal as a different optical signal (e.g., via the optical transmitter 44B and encoded in light 178). The different optical signal may be indicative of a relative position between the HMD 160 and the optical sensor 18B. The HMD 160 may use the optical receiver 54 to receive the light 178. Further, the HMD 160 may use the controller 16 to compute the position data associated with the HMD 160 (e.g., the coordinates 26 with respect to the optical sensor 18B and/or the area 14). The coordinates 26 may include coordinate data of the HMD 160 with respect to the optical sensors 18B and/or the area 14.

The HMD 160 may utilize the position data (e.g., the coordinates 26) to provide information to the guest 170 and/or to adjust operation of the HMD 160. For example, the HMD 160 may display a location of the guest 170 in the area 14. As another example, the HMD 160 may utilize the position data to display particular imagery (e.g., AR and/or VR imagery) for visualization by the guest 170 based on the position data (e.g., in coordination with effects in the area 14 and/or the real-world environment in the area 14). In particular, the HMD 160 may display the corresponding imagery in coordination with effects, such as sound effects, visual effects, and/or haptic effects in the area 14 (e.g., AR or VR imagery of a dragon in coordination with heat from a heat source; AR imagery of a bird that appears to be perched on a rooftop due to coordination with background imagery of the rooftop on a display in the real-world environment). In this way, the optical tracking system 12 may enable or improve certain coordinated events (e.g., theme park events including the guest 170 and other guests) based on the relative positions of multiple guests including the guest 170, resulting in enhanced experience in the area 14.

As noted herein, the HMD 160 may include AR devices providing an enhanced, interactive version of the real-world environment (e.g., the area 14) achieved through imagery displayed on the HMD 160 overlaid with and/or in coordination with other digital visual elements, sounds, and/or other sensory stimuli (e.g., via haptic technology). In such cases, the HMD 160 may utilize the location of the HMD 160 to provide more accurate overlay of the imagery onto the real-world environment, which may further improve the experience of the guest 170 via certain coordinated events and effects.

Although the controller 16 is described as being a standalone part of the HMD 160, it should be noted that, in an embodiment, the functions and/or components of the controller 16 may be integrated into the HMD 160. For example, in an embodiment, the HMD 160 may not include the controller 16. Instead, the similar functions, such as computing the position data associated with the HMD 160 (e.g., the coordinates 26) may be performed by any suitable processor of the HMD 160 and/or communicatively coupled to the HMD 160 (e.g., via a wired or wireless connection).

In an embodiment, each of the optical sensors 18 may send a simplified version of data indicative of the location of the HMD 160 to the HMD 160 for further processing. For example, the optical sensor 18A (including a camera) may do a basic blob detection to identify image frames having light from the light emitter 24F and then transmit only the identified image frames to the HMD 160, thereby reducing an amount of transmitted data and improving the communication bandwidth.

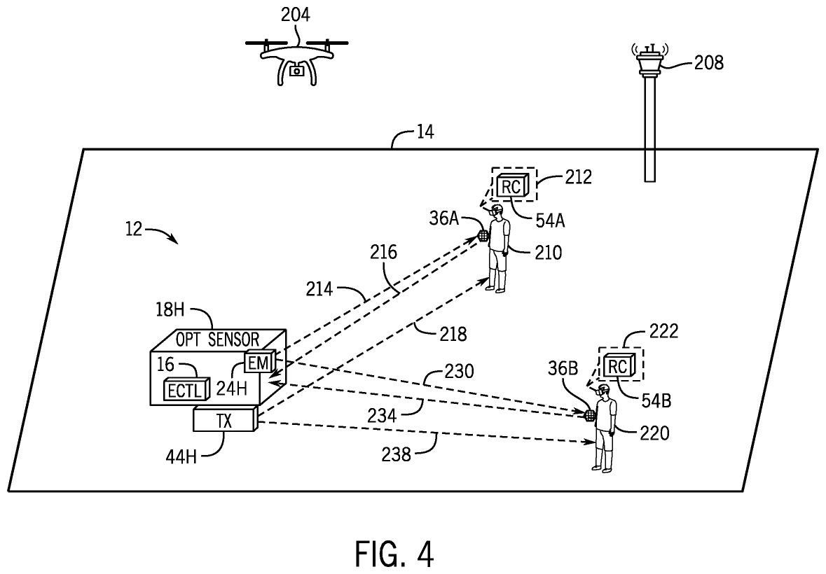

FIG. 4 is a schematic diagram of an embodiment of the optical tracking system 12 that includes one optical sensor 18H with a light emitter 24H for tracking multiple objects. For example, the multiple objects being tracked may include an HMD 212 worn by a guest 210 and an HMD 222 worn by a guest 220. As shown, the controller 16 is integrated with the optical sensor 18H.

For example, the optical sensor 18H may include one or more wide angle view cameras that may capture images of multiple objects at different locations of the area 14. In certain cases, the optical sensor 18H may be implemented on, or in one or more flying objects (e.g., a drone 204) or a structure (e.g., a signal tower 208). Such flying object or structure may provide a better view for the optical sensor 18H to improve the object tracking in the area 14. In an embodiment, the object 20 may include the flying object (e.g., the drone 204). The drone 204 may include an autonomously controlled (e.g., according to programmed flight paths) and/or a remotely controlled (e.g., according to control inputs provided by an operator at a remote location) aerial vehicle.

As shown, the optical sensor 18H may simultaneously track the multiple objects (e.g., the HMDs 212 and 222). For example, the optical sensor 18H (e.g., including the one or more wide angle view cameras) may identify and track each object by detecting a known marker pattern or shape associated with a retroreflector 36 coupled to the corresponding object. Alternatively, in an embodiment, the optical sensor 18H may identify and track each object (e.g., the HMDs 212 and 222) by reading the light emitted from respective emitters 24 containing active IR pulses (e.g., having different frequencies from each object being tracked).

The HMD 212 may have a retroreflector 36A (e.g., coupled to a frame, visor, and/or band of the HMD 212) that may reflect light (e.g., IR or visible light) emitted from the light emitter 24H of the optical sensor 18H. Similarly, the HMD 222 may have a retroreflector 36B (e.g., coupled to a frame, visor, and/or band of the HMD 222) that may reflect light (e.g., IR or visible light) emitted from the light emitter 24H of the optical sensor 18H. It should be appreciated the retroflectors 36A and 36B may each represent or include multiple distinct retroflectors.

For example, the retroreflector 36A may reflect a portion of light 214 emitted from the light emitter 24H. Reflected light (e.g., light 216) may reach the optical sensor 18H. The optical sensor 18H may detect the light 216 and generate a first signal indicative of a location of the HMD 212 with respect to the optical sensor 18H. The optical sensor 18H may generate the first signal based on the detected light 216. The first signal may be indicative of a relative position between the guest 210 and the optical sensor 18H and/or the area 14.

The controller 16 (e.g., the processors 82 of the controller 16) may be configured to receive (e.g., via the communication component 86) the first signal transmitted from the optical sensor 18H. In response, the controller 16 may compute position data associated with the guest 210 and/or the HMD 212. For example, based on the first signal, the controller 16 may compute the position data of the HMD 212 with respect to the optical sensor 18H. Computing the position data may include analyzing the attributes of the light 216, computing a relative distance and orientation between the HMD 212 and the optical sensor 18H, retrieving coordinates 22 of the optical sensor 18H, and computing coordinates 26 of the HMD 212 (e.g., relative coordinates between the optical sensor 18H and the HMD 212 and/or between the HMD 212 and the area 14). The coordinates 26 of the HMD 212 may include coordinate data of the HMD 212 with respect to the optical sensor 18H. In an embodiment, the controller 16 may use stored location data (e.g., the coordinates 22 of the optical sensor 18H) to directly compute the coordinates 26 of the HMD 212 with respect to the area 14.

After computing the coordinates 26 of the HMD 212, the controller 16 may send (e.g., via the communication component 88) the coordinates 26 of the HMD 212 to the optical sensor 18H. In response, the optical sensor 18H may send (e.g., via an optical transmitter 44H or the emitter 24H) a first optical signal to the HMD 212 via light 218. The first optical signal may include the coordinates 26 of the HMD 212. The HMD 212 may use an optical receiver 54A to receive the light 218 carrying the first optical signal.

Similarly, the retroreflector 36B on the HMD 222 may reflect a portion of light 230 emitted from the light emitter 24H. Reflected light (e.g., light 234) may reach the optical sensor 18H (e.g., from a different incident angle relative to the light 216). The optical sensor 18H may detect the light 234 and generate a second signal indicative of a location of the HMD 222 with respect to the optical sensor 18H. The optical sensor 18H may generate the second signal based on the detected light 234. The second signal may be indicative of a relative position between the guest 220 and the optical sensor 18H and/or the area 14.

The controller 16 (e.g., the processors 82 of the controller 16) may be configured to receive the second signal transmitted from the optical sensor 18H. In response, the controller 16 may compute position data associated with the guest 220 and/or the HMD 222. For example, based on the second signal, the controller 16 may compute the position data of the HMD 222 with respect to the optical sensor 18H. Computing the position data may include analyzing the attributes associated with the light 234, computing a relative distance and orientation between the HMD 222 and the optical sensor 18H, retrieving the coordinates 22 of the optical sensor 18H, and computing coordinates 26 of the HMD 222 (e.g., relative coordinates between the optical sensor 18H and the HMD 222 and/or between the HMD 222 and the area 14). The coordinates 26 of the HMD 222 may include coordinate data of the HMD 222 with respect to the optical sensor 18H. In an embodiment, the controller 16 may use stored location data (e.g., the coordinates 22 of the optical sensor 18H) to directly compute the coordinates 26 of the HMD 212 with respect to the area 14.

After computing the coordinate 26 of the HMD 222, the controller 16 may send (e.g., via the communication component 88) the coordinates 26 of the HMD 222 to the optical sensor 18H. In response, the optical sensor 18H may send (e.g., via the optical transmitter 44H or the emitter 24H) a second optical signal to the HMD 222 via light 238. The second optical signal may include the coordinates 26 of the HMD 222. The HMD 222 may use the optical receiver 54B to receive the light 238 carrying the second optical signal.

Although the optical tracking system 12 described herein with respect to FIGS. 1-4 includes using multiple optical sensors 18 to track at least one object (e.g., the object 20) or using at least one optical sensor (e.g., optical sensor 18H) to track multiple objects (e.g., the HMDs 212 and 222), it should be noted that, in an embodiment, the optical tracking system 12 may be implemented with different features. For example, in an embodiment, the optical tracking system 12 may include using multiple optical sensors 18 to simultaneously track multiple objects in the area 14. For example, only the light that is in view of a given object (e.g., the HMD 212 or the HMD 222) may be used to transmit data to that given object. Additionally, or alternatively, only the data intended for the given object that is in view of an optical sensor may be transmitted by the optical sensor (e.g., via directional light sources and/or light signals encoded for a particular object).

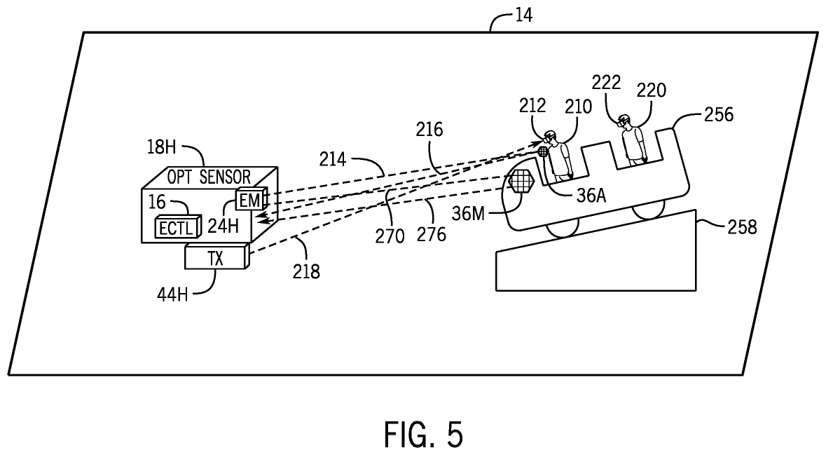

With the foregoing in mind, FIG. 5 is an example application 250 in an amusement park using the optical tracking system 12. The guests 210 and 220 may wear the HMDs 212 and 222, respectively, when riding a ride vehicle 256 (e.g., traveling on a path 258) in the area 14 (e.g., an amusement park). As mentioned herein, the HMD 212 may have the retroreflector 36A that may reflect a portion of the light 214 emitted from the light emitter 24H. Reflected light (e.g., the light 216) may reach the optical sensor 18H that may detect the light 216 and generate the first signal indicative of the relative position between the HMD 212 and the optical sensor 18H. Moreover, the optical sensor 18H may generate the second signal indicative of the relative position between the HMD 222 and the optical sensor 18H based on the light 234 reflected from the retroreflector 36B coupled to the HMD 222. For clarity, the light 234 and the retroreflector 36B are not shown in FIG. 5.

The controller 16 (e.g., the processors 82 of the controller 16) may be configured to receive (e.g., via the communication component 86) the first and the second signals from the optical sensor 18H. In response, the controller 16 may compute position data associated with the HMDs 212 and 222. The position data may include respective coordinates of the HMDs 212 and 222. After computing the coordinates of the HMDs 212 and 222, the controller 16 may send (e.g., via the communication component 88) the coordinates of the HMDs 212 and 222 to the optical sensor 18H, which may send (e.g., via the optical transmitter 44H or the emitter 24H) the first optical signal to the HMD 212 via the light 218 and send the second optical signal to the HMD 212 via the light 238 (not shown in FIG. 5 for clarity). The first and the second optical signal may include the respective relative coordinates of the HMDs 212 and 222 with respect to the optical sensor 18H and/or the area 14.

Additionally, the carried vehicle 256 may have a retroreflector 36M that may reflect a portion of light 270 emitted from the light emitter 24H. Reflected light (e.g., light 276) may reach the optical sensor 18H that may detect the light 276 and generate a third signal indicative of the relative position between the carried vehicle 256 and the optical sensor 18H. The controller 16 may be configured to receive (e.g., via the communication component 86) the third signal from the optical sensor 18H. In response, the controller 16 may compute position data associated with the ride vehicle 256. The position data may include coordinates of the ride vehicle 256 (e.g., relative to the optical sensor 18H, the HMDs 212 and 222, and/or the area 14).

Furthermore, the controller 16 may utilize the coordinates of the HMD 212, the HMD 222, and the ride vehicle 256 to compute a first relative position between the HMD 212 and the ride vehicle 256 and a second relative position between the HMD 222 and the ride vehicle 256. The controller 16 may use the first and the second relative positions to perform certain proactive and/or preventive actions associated with the HMDS 212 and 222 and the ride vehicle 256. For example, the controller 16 may determine that the HMD 212 may have a potential maintenance issue based on the first relative position indicating the HMD 212 (and thus, the guest 210) may be seated too close to a gate of the ride vehicle 256. In response to the potential maintenance issue, the controller 16 may send (e.g., via the communication component 86) a command to a ride vehicle controller of the ride vehicle 256. The command may cause the ride vehicle controller to stop the operation of the ride vehicle 256 for further diagnostic of the potential maintenance issue. Such proactive and/or preventive actions may improve the experience of the guests 210 and 220 while riding on the ride vehicle 256 in the area 14. It should be appreciated that similar features may be implemented for any users (e.g., guests and/or employees) of the area 14. Further, the optical tracking system 12 may be utilized to track other types of objects carried or worn by the users (e.g., bands, shoes, removable stickers, stamps, helmets). For example, the guests 210 and 220 may wear the HMDs 212 and 222 with the retroreflectors 36A and 36B that are tracked to facilitate coordination of imagery presented by the HMDs 212 and 222 and/or bands with retroflectors that are separately tracked to facilitate presentation of alerts and/or operational changes for various maintenance issues.

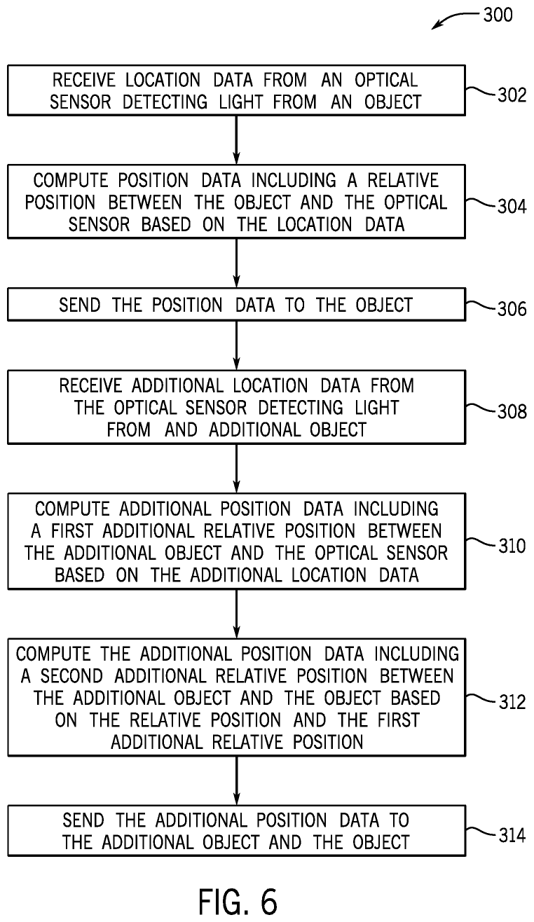

FIG. 6 is a flow diagram of a method 300 for using the optical tracking system described herein to track objects. The optical tracking system may perform operations described below via the one or more processors (referred to as the processors 82) based on processor-executable code stored in the memory. The processors may execute the processor-executable code to perform object tracking based on tracking data transmitted from one or more optical sensors that may detect light (e.g., light reflected or emitted) from the objects (e.g., object 20, HMD 160, HMD 212, HMD 222). Based on the tracking data and other relevant data, the processors 82 may compute position data including a relative position between each object and a corresponding optical sensor 18, and/or a relative position between each object and an area (e.g., a coordinate system established for the area). Further, the processor 82 may send respective position data to the objects.

Although the method 300 is described in a particular order, it should be noted that the method 300 may be performed in any suitable order and is not limited to the order presented herein. It should also be noted that although each processing block is described below in the method 300 as being performed by the optical tracking system, other suitable computing systems may perform the methods described herein.

Referring now to FIG. 6, at block 302, the optical tracking system may receive location data from an optical sensor (e.g., the optical sensor 18A) detecting light from an object (e.g., the object 20, HMD 160, HMD 212). The optical tracking system may use the communication component to receive the location data via wired and/or wireless communication lines (e.g. electric cables 46) or wirelessly (e.g., using radio or optical signals). The location data include location information indicative of a location of the object. In an embodiment, the optical sensor may generate the location data based on the light reflected from the object. For example, the optical sensor may include (or couple with) a light emitter or illuminator (e.g., the light emitter 24A) that may emit illumination light (e.g., IR or visible light). A portion of the illumination light may be reflected by one or more retroreflectors (e.g., retroreflector 36A) built-in or coupled to the object. The optical sensor may detect the reflected light and generate the location data based on the reflected light from the object.

In an embodiment, the object may include (or couple with) a light emitter (e.g., the light emitter 24F) that may emit active light (e.g., IR or visible light). The optical sensor may detect the active light and generate the location data based on the active light emitted from the light emitter the object.

At block 304, the optical tracking system may compute position data including a relative position between the object and the optical sensor based on the location data. The optical tracking system may perform a set of actions to compute the position data, such as analyzing certain attributes (e.g., arriving time, direction, light intensity, frequency, and/or polarization) associated with the light reflected or actively emitted from the object, computing a relative distance and orientation between the object and the optical sensor, receiving or retrieving a sensor coordinate (e.g., coordinates 22 including location coordinates [X_{C}, Y_{C}, Z_{C}] and orientation data [YAW_{C}, PITCH_{C}, and ROLL_{C}]) of the optical sensor, and computing the position data including an object coordinate (e.g., coordinate 26 may include Cartesian coordinates [X_{O}, Y_{O}, Z_{O}] and orientation information [YAW_{O}, PITCH_{O}, and ROLL_{O}]) of the object. The position data may include the relative location and orientation data between the object and the optical sensor and/or between the object and the area.

At block 306, the optical tracking system may send the position data to the object. In an embodiment, the processors may be a component of a controller (e.g., controller 16) communicatively coupled to the optical sensor. The processors may send the position data to the optical sensor via the wired and/or wireless communication lines (e.g. electric cables 46) or wirelessly (e.g., using radio or optical signals). In response, the optical sensor may use an optical transmitter (e.g., optical transmitter 44A or emitter 24A) to transmit the position data via an optical signal (e.g., IR or visible light signal) to the object. The object may include an optical receiver that may receive the optical signal. The optical signal containing the position data may enable the object to be aware of the location of the object with respect to the optical sensor and/or the area.

In an embodiment, the processors may be a component of a device (e.g., a device coupled to or integrated into the object). The processors may send the position data directly to the object. With the awareness of the location of the object, the optical tracking system may enable or improve certain coordinated events (e.g., theme park events, including special effects) based on the position data, resulting in enhanced experience in the coordinated events in the area.

At block 308, the optical tracking system may receive additional location data from the optical sensor detecting light from an additional object. For example, the additional object may include another object (e.g., HMD 222) with proximity of the first object (e.g., HMD 212) or participating in the coordinated events with the first object. In some cases, the additional object may include the ride vehicle (e.g., ride vehicle 256) ridden by the guest and the additional guest.

The additional object may include (or couple with) an additional one or more retroreflectors (e.g., retroreflector 36B) built-in or coupled to the additional object. A portion of the illumination light emitted from the light emitter or illuminator (e.g., the light emitter 24A) may be reflected back to the optical sensor that may detect the reflected light and generate the additional location data based on the reflected light from the additional object. In an embodiment, the additional object may include (or couple with) an additional light emitter that may emit active light (e.g., IR or visible light). The optical sensor may detect the active light and generate the additional location data based on the active light emitted from the additional light emitter of the additional object.

At block 310, the optical tracking system may compute additional position data including a first additional relative position between the additional object and the optical sensor based on the additional location data. Computing the first additional relative position may include analyzing the attributes (e.g., arriving time, direction, light intensity, frequency, and/or polarization) associated with the light reflected or actively emitted from the additional object, computing a relative distance and orientation between the additional object and the optical sensor, retrieving the sensor coordinate of the optical sensor, and computing the first additional relative position including an additional object coordinate and orientation information of the additional object. The first additional relative position may include relative location and orientation data between the additional object and the optical sensor and/or between the additional object and the area.

Further, at block 312, the optical tracking system may compute the additional position data including a second additional relative position between the additional object and the object based on the relative position and the first additional relative position. For example, the optical tracking system may compute a relative location between the object and the additional object based on respective location coordinates of the object and the additional object included in the relative position and the first additional relative position. The optical tracking system may also compute a relative orientation between the object and the additional object based on orientation coordinates of the object and the additional object included in the relative position and the first additional relative position.

At block 314, the optical tracking system may send the additional position data to the additional object and/or the object. In an embodiment, the optical tracking system may send the additional position data to the optical sensor via the wired and/or wireless communication lines (e.g. electric cables 46) or wirelessly (e.g., using radio or optical signals). In response, the optical sensor may use the optical transmitter (e.g., optical transmitter 44A or emitter 24A) to transmit the additional position data via the optical signal (e.g., infrared or visible light signal) to the additional object. The additional object may use an additional optical receiver to receive the optical signal. The optical signal containing the additional position data may enable the additional object to be aware of the location of the additional object with respect to the optical sensor. In an embodiment, the processors may be a component of another device coupled to or integrated into the additional object. The processors may send the additional position data directly to additional object.

The optical tracking system may enable or improve certain coordinated events (e.g., theme park events including the object and the additional object) based on the position data and the additional position data, resulting in enhanced experience in the coordinated events in the area. For example, the object may be worn by a guest (e.g., guest 210) and the additional object may be worn by another guest (e.g., guest 220) that may participate a coordinated event (e.g., riding event using the ride vehicle 256). In some embodiment, the additional object may be a ride vehicle that carries the object through the area.

In an embodiment, the optical tracking system may utilize the position data and the additional position data to enable the object and the additional object to be aware of a relative position between them in a real time manner. In this way, the object and the additional object may perform or participate an event with improved coordination, resulting in an enhanced experience during the event. In an embodiment, the optical tracking system may generate a signal (e.g., including an alert, such as a text message and/or an audible sound) indicative of a potential issue (e.g., maintenance issue) based on the position data and the additional position data. The optical tracking system may send the signal to at least one device or system, such as a ride vehicle controller, the object, and/or the additional object via wired and/or wireless communication lines (e.g. electric cables 46) or wirelessly (e.g., using radio or optical signals). In this way, at least one device or system may be aware of the potential issue and make corresponding actions to avoid the potential issue, resulting in an enhanced experience during the event.

It should be noted that the embodiments of the optical tracking system described herein may include certain implementations of the optical tracking system. The optical tracking system may be implemented in different methods with different components and/or different functionalities.

For example, in one embodiment, certain sensors mounted or coupled to certain tracked devices (e.g., HMDs) may include cameras or angle sensing light sensors. This may allow the tracking devices to limit the areas that they are “looking at” to only the areas where specific cameras or angle sensing light sensors are configured to observe. This may increase communication bandwidth when each camera or angle sensing light sensor sends only relevant data to each tracked device.

In one embodiment, position data associated with the tracked objects may be calculated directly on, or in each optical sensor, eliminating an external processing device (e.g., the controller 16) and increasing a flexibility of the optical tracking system.

In one embodiment, the position data may be transmitted along with a unique identifier (e.g., via modulation or flashing of the light) to the object and/or along with a timestamp. In this way, the object may receive the position data intended for the object and/or be able to discard data that is not timely (e.g., the timestamp indicates prior data).

In one embodiment, a 3D location and orientation (e.g., position and pose) of a tracked object may be calculated by multiple processors (e.g., processors built into the optical sensor) in a collaboration manner. The 3D position and the pose may be sent to the tracked object, which may be used for enabling certain enhanced actions, such as enabling intelligent devices (e.g., HMDs with AR, other digital visual elements, sounds, haptics, or holographic technology) to provide an enhanced, interactive 3D version (including the location and the orientation) of a real-world environment. Such interactive 3D version may further improve the use of the tracked objects and experience of the guests in certain individual and/or coordinated events.

The systems and methods in the present disclosure provide a variety of tracking systems that may be used to track objects and provide position data. For example, such tracking systems may include using data transmission via light, 2D and 3D object tracking via infrared (IR) reflection using retro-reflective markers, 2D and 3D object tracking via IR light emitted from the tracked objects, “inside out” tracking solutions that may calculate the position of a tracked object without off board devices, tracking objects in 2D and 3D space using light house style devices mounted in a space to receive optical signals from the tracked objects and send the relative position data to the tracked object, motion capture of virtual cameras during visual effects shooting for film making, and so on.

Additionally, the systems and methods in the present disclosure provide for combining technologies to create new solutions with improved object tracking capabilities. For example, the new solutions may utilize similar hardware requirements of certain existing motion capture systems. As such, adding additional functionalities associated with the new solutions may be done with relatively little work and the new solutions may work in a similar way to existing motion capture systems, but may have less issues (e.g., data transmission issues due to signal interference or network bandwidth).

While only certain features of present embodiments have been illustrated and described herein, many modifications and changes will occur to those skilled in the art. It is, therefore, to be understood that the appended claims are intended to cover all such modifications and changes that fall within the true spirit of the disclosure. Further, it should be understood that certain elements of the disclosed embodiments may be combined or exchanged with one another. It should be appreciated that any features shown in and/or described with reference to FIGS. 1-6 may be combined in any suitable manner. For example, the controller 16 may be included in the object 20 of FIG. 1 and/or the object 20 of FIG. 2 (e.g., the coordinates 26 are determined at the object 20).

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
an optical sensor configured to detect an object in an area; and
a controller configured to:
receive first data indicative of a first location of the object from the optical sensor;
receive second data indicative of a second location of the optical sensor;
compute position data based on the first location and the second location; and
transmit the position data to the object via an optical signal.

2. The system of claim 1, wherein the optical sensor is configured to detect light from the object.

3. The system of claim 2, wherein the light comprises infrared light reflected from the object.

4. The system of claim 3, wherein the optical sensor comprises a light emitter configured to emit illumination infrared light that is reflected from the object as the infrared light.

5. The system of claim 4, wherein the light emitter comprises one or more infrared light-emitting diodes (LEDs), one or more actively powered infrared illuminators, one or more flashing infrared light sources, one or more digital projectors or directional light sources, or any combination thereof.

6. The system of claim 4, wherein the object comprises one or more retroreflectors configured to reflect a portion of the illumination infrared light to the optical sensor as the infrared light.

7. The system of claim 2, wherein the light comprises visible light reflected from the object.

8. The system of claim 2, wherein the light comprises infrared light emitted from a light emitter of the object.

9. The system of claim 1, wherein the position data comprises location data and orientation data of the object, wherein the location data comprises a two-dimensional coordinate system or a three-dimensional coordinate system associated with the area, wherein the orientation data comprises orientation coordinates comprising YAW, PITCH, and ROLL information of the object.

10. The system of claim 1, comprising one or more additional optical sensors configured to detect the object in the area, wherein the controller is configured to receive additional data indicative of the first location of the object from the one or more additional optical sensors.

11. The system of claim 1, wherein the controller is configured to transmit the position data to an additional object via an additional optical signal.

12. The system of claim 1, comprising the object, wherein the object comprises a head-mounted display that is configured to display imagery based on the position data.

13. The system of claim 1, wherein the controller is integrated with the optical sensor or the object.

14. An optical tracking system, comprising:
an optical sensor configured to detect a first object and a second object in an area; and
a controller configured to:
receive first data indicative of a first location of the first object from the optical sensor;
receive second data indicative of a second location of the second object from the optical sensor;
receive third data indicative of an additional location of the optical sensor;
compute first position data for the first object based on the first location data and the additional location;
compute second position data for the second object based on the second location and the additional location;
instruct a light emitter to transmit the first position data to the first object via a first optical signal; and
instruct the light emitter to transmit the second position data to the second object via a second optical signal.

15. The optical tracking system of claim 14, wherein the first object and the second object comprise autonomously or remotely controlled flying objects that move within the area.

16. The optical tracking system of claim 14, wherein the first object and the second object comprise a respective object light emitter configured to emit light detectable by the optical sensor, or a respective retroreflector configured to reflect a portion of illumination light to generate reflected light detectable by the optical sensor.

17. A method, comprising:
receiving, at one or more processors, location data from an optical sensor configured to detect light from an object in an area;
computing, via the one or more processors, position data indicative of a relative position between the object and the area based on the location data; and
sending, via an optical transmitter, the position data to the object.

18. The method of claim 17, comprising:
receiving, at the one or more processors, additional location data from the optical sensor configured to detect additional light from an additional object;
computing, via the one or more processors, additional position data indicative of a first additional relative position between the additional object and the area based on the additional location data; and
sending, via the optical transmitter, the additional position data to the additional object and the object.

19. The method of claim 17, comprising projecting, via one or more displays associated with the object, imagery based on the position data.

20. The method of claim 17, comprising outputting, via an output device of the object, one or more effects based on the position data.
